(19) United States
(12) Patent Application Publication
(10) Pub. No.: US 2011/0318477 A1
(43) Pub. Date: Dec. 29, 2011

(54) Apparatus and method for producing a sheet material

(76) Inventors: Norimitsu Sanbongi, Chiba-shi (JP); Takanori Okayasu, Chiba-shi (JP); Kazuo Tani, Chiba-shi (JP); Minoru Hoshino, Chiba-shi (JP); Noriyoshi Shoji, Chiba-shi (JP)

(21) Appl. No.: 13/199,497

(22) Filed: Aug. 31, 2011

Related U.S. Application Data
(62) Division of application No. 12/011,380, filed on Jan. 24, 2008.

(30) Foreign Application Priority Data
Feb. 14, 2007 (JP) 2007-033145

(51) Int. Cl. B05D 5/00; B05D 3/12; B05D 1/26

(52) U.S. Cl. 427/58; 427/256

(57) ABSTRACT

Provided is an apparatus for producing a sheet material including: an RFID reader (11) for reading information froth an RFID tag; a sheet supply unit (12) for supplying the sheet material (4) having a heat-sensitive printing layer on one surface of a sheet-type base material, and having a heat-sensitive adhesive layer on the other surface of the sheet-type base material; a printing unit (13) for performing printing on the heat-sensitive printing layer of the sheet material (4) supplied from the sheet supply unit (12); a thermal activation unit (15) for heating the heat-sensitive adhesive layer of the sheet material (4), which is printed by the printing unit (13), to develop an adhesive force of the heat-sensitive adhesive layer; and a control unit (16) for controlling the thermal activation unit (15) to develop the adhesive force in a predetermined area of the heat-sensitive adhesive layer other than an area facing the RFID tag so as to form an adhesive area to be attached to the article, and for controlling the printing unit (13) to print predetermined information on the heat-sensitive printing layer, based on the information read from the RFID tag by the RFID reader (11), thereby making it possible to match information of the tag with information printed on the sheet material with reliability, and to simply attach the tag to the article.

### BACKGROUND OF THE INVENTION

1. Field of the Invention

The present invention relates to an apparatus and a method for producing a sheet material to be attached to an article, the sheet material covering a tag to/from which information can be written/read in a non-contact state.

2. Description of the Related Art

In order to manage articles and the like, for example, there is employed a so-called radio frequency identification (RFID) tag which contains an integrated circuit (IC) and an antenna that are electrically connected to each other, and to/from which information can be written/read in a non-contact state.

As an example of a conventional RFID label having the RFID tag of this type, JP 2000-222545 A, for example, discloses an RFID label which includes film materials bonded to the RFID tag. In the conventional RFID label, both surfaces of the RFID tag are covered with the film materials, one of the film materials having a printing layer formed thereon, the other of the film materials having an adhesive layer formed thereon.

Further, the conventional RFID label is produced into a label form by use of an apparatus for producing a label, and then desired information is written into the IC of the RFID tag with an RFID tag writer. Information such as characters and barcodes are printed on a printing layer with a printing device, and the RFID label is attached to an article through the adhesive layer to be used. The conventional RFID label is relatively expensive, but is thrown away after one use because of being difficult to reuse the RFID tag by peeling the RFID tag off from the RFID label.

In place of the conventional RFID label, there is widely used an RFID label having an RFID tag which contains an IC and an antenna that are coated with a resin material, has various types such as a card type, a coin type, and a stick type, and which can be reused. The RFID tag of this type has an inconvenience in that information written in the IC cannot be confirmed with eyes. Accordingly, it is necessary to separately prepare a display member such as a printing sheet or a printing label on which information is printed, and to use the RFID tag in combination with the display member. Further, in a case of using the RFID tag of this type, it is necessary to attach the RFID tag to an article. Accordingly, for example, a case for receiving the RFID tag is stuck to the article, and the display member on which information has been printed is received in the case with the RFID tag, thereby being used for managing the article.

Incidentally, as described above, in the case of using the conventional RFID tags of various types such as the card type, the coin type, and the stick type, the RFID tag and the display member on which information of the RFID tag has been printed are handled separately. For this reason, when the RFID tag and the display member are erroneously matched with each other, there is a fear that the information of the RFID tag and the information of the display member do not match with each other in some cases.

Further, in the case of handling the RFID tag, it is necessary to attach the above-mentioned case to the article, and to additionally provide a structure, such as the case, for attaching the RFID tag to the article. It is also necessary to change each structure for attaching the RFID tag and the display member to the article to adapt to the type of the RFID tag, the size of the display member, or the like. Thus, there is an inconvenience in that an operation of attaching the RFID tag to the article is complicated.

### SUMMARY OF THE INVENTION

It is an object of the present invention to provide an apparatus and a method for producing a sheet material capable of producing a label of a desired type based on information read from a tag, thereby making it possible to match information of the tag with information printed on a sheet material with reliability, and to simply attach the tag to an article.

In order to achieve the above object, the present invention provides an apparatus for producing a sheet material to be attached to an article, the sheet material covering a tag which contains an antenna and an integrated circuit that are electrically connected to each other and are coated with a coating material, and to/from which information can be written/read in a non-contact state, the apparatus including: reading means for reading information from the tag; sheet supply means for supplying the sheet material having a printing layer on one surface of a sheet-type base material, and having a heat-sensitive adhesive layer on the other surface of the sheet-type base material; printing means for performing printing on the printing layer of the sheet material supplied from the sheet supply means; and thermal activation means for heating the heat-sensitive adhesive layer of the sheet material, which is printed by the printing means, to develop an adhesive force of the heat-sensitive adhesive layer. The apparatus for producing a sheet material also includes control means for controlling the thermal activation means to develop the adhesive force in a predetermined area of the heat-sensitive adhesive layer other than an area facing the tag so as to form an adhesive area to be attached to the article, and which controls the printing means to print predetermined information on the printing layer, based on the information read from the tag by the reading means.

In the apparatus for producing a sheet material according to the present invention with the above-mentioned structure, the control means controls each of the printing means and the thermal activation means based on the information read from the tag by the reading means, thereby printing the predetermined information on the sheet material and developing the adhesive force in the predetermined area of the sheet material, based on the information of the tag. As a result, a label of a desired type can be easily produced based on the information read from the tag, thereby making it possible to match the information of the tag with the information printed on the sheet material with reliability, and to simply attach the tag to the article with the sheet material.

Further, the thermal activation means of the apparatus for producing a sheet material according to the present invention may form, on the heat-sensitive adhesive layer, a first adhesive area to be attached to an article, and a second adhesive area in which the sheet material is folded back to be bonded so as to hold the tag.

Further, the printing means of the apparatus for producing a sheet material according to the present invention may perform printing of duplicate information on the first printing area position on the back surface of the first adhesive area and on the second printing area positioned on the back surface of the second adhesive area. As a result, for example, in a case where the RFID tag is collected from the article, even when the first printing area attached to the article and the second printing area are separated from each other, the printed information can be shared between the first printing area and the second printing area.

The present invention also provides a method of producing a sheet material for attaching a tag to an article, the tag containing an antenna and an integrated circuit that are electrically connected to each other and are coated with a coating material, and to/from which information can be written/read in a non-contact state. The method of producing a label includes the steps of: reading information from the tag; supplying the sheet material having a printing layer on one surface of a sheet-type base material, and having a heat-sensitive adhesive layer on the other surface of the sheet-type base material; developing an adhesive force in a predetermined area of the heat-sensitive adhesive layer other than an area facing the tag so as to form an adhesive area to be attached to the article, based on the information read from the tag; and printing predetermined information on the printing layer based on the information read from the tag.

According to the present invention as described above, the adhesive force is developed in the predetermined area of the heat-sensitive adhesive layer and the predetermined information is printed on the printing layer, based on the information read from the tag. As a result, a label of a desired type can be produced based on the information read from the tag, thereby making it possible to match the information of the tag with the information printed on the sheet material with reliability, and to simply attach the tag to the article with the sheet material.

### BRIEF DESCRIPTION OF THE DRAWINGS

In the accompanying drawings:

FIG. 1 is a schematic diagram showing a structure of an apparatus for producing a sheet material according to an embodiment of the present invention;

FIG. 2 is a block diagram showing the apparatus for producing a sheet material;

FIG. 3 is a flowchart for explaining operations of the apparatus for producing a sheet material;

FIG. 4 is a plan diagram showing adhesive areas of a heat-sensitive adhesive layer of a sheet material heated by a thermal activation unit;

FIGS. 5A to 5D are diagrams each showing an RFID label of a case type;

FIG. 6 is a plan diagram showing an adhesive area of the heat-sensitive adhesive layer of the sheet material heated by the thermal activation unit;

FIGS. 7A to 7D are diagrams each showing an RFID label of a cover type; and

FIGS. 8A to 8E are diagrams for explaining a modified example of the RFID label of the case type.

### DETAILED DESCRIPTION OF THE PREFERRED EMBODIMENTS

Hereinafter, exemplary embodiments of the present invention will be described with reference to the drawings.

An apparatus for producing a sheet material according to an embodiment of the present invention is an apparatus for producing a sheet material to be attached to an article in a state where a so-called RFID tag, which contains an antenna and an IC electrically connected to each other and to/from which information can be written/read through a non-contact communication using a radio wave, is covered. For the RFID tag according to the embodiment, there are employed RFID tags of various types such as a card type, a coin type, and a stick type, each of which contains the IC and the antenna coated with a resin material or the like, and which can be reused by rewriting information stored in the IC. The sheet material used in the embodiment includes a sheet-type base material, a heat-sensitive printing layer formed on one surface of the sheet-type base material, and a heat-sensitive adhesive layer formed on the other surface of the sheet-type base material.

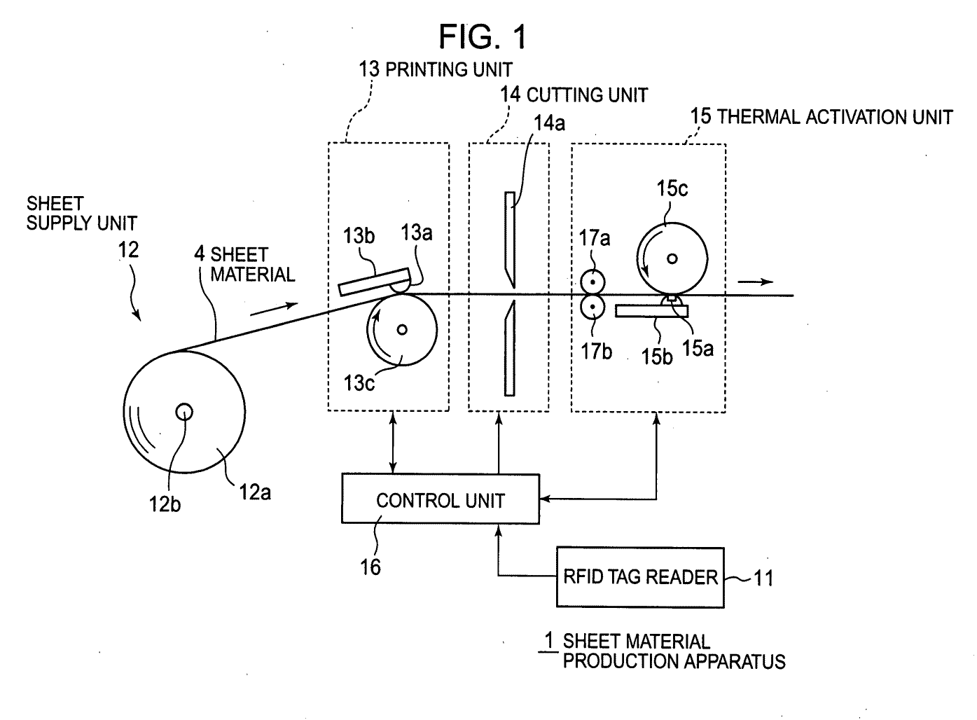

As shown in FIG. 1, a sheet material production apparatus 1 according to the embodiment includes: an RFID tag reader 11 (reading means) for reading information from the RFID tag; a sheet supply unit 12 (sheet supply means) for supplying a sheet material 4 used for attaching the RFID tag to an article; a printing unit 13 (printing means) for performing printing on a heat-sensitive printing layer of the sheet material 4 supplied from the sheet supply unit 12; a cutting unit 14 (cutting means) for cutting the sheet material 4 which is printed by the printing unit 13; and a thermal activation unit 15 (thermal activation means) for heating the heat-sensitive adhesive layer of the sheet material 4, which is cut by the cutting unit 14, to develop an adhesive force thereof. Further, the sheet material production apparatus 1 includes a control unit 16 (control means) for controlling each of the printing unit 13, the cutting unit 14, and the thermal activation unit 15 based on the information read from the RFID tag by the RFID tag reader 11.

The RFID tag reader 11 includes a communication circuit (not shown) for writing and reading information through a non-contact communication with respect to the IC of the RFID tag, and the communication circuit is electrically connected to the control unit 16. Note that the information read from the IC of the RFID tag by the RFID tag reader 11 contains information on various types of the RFID tag, such as a card type, a coin type, and a stick type, and information to be printed on the heat-sensitive printing layer.

The sheet supply unit 12 includes a spindle 12b for rotatably supporting a sheet supply roll 12a, which is formed of a continuous-form sheet material 4 wound into a roll, and a drive mechanism (not shown) for rotationally driving the spindle 12b.

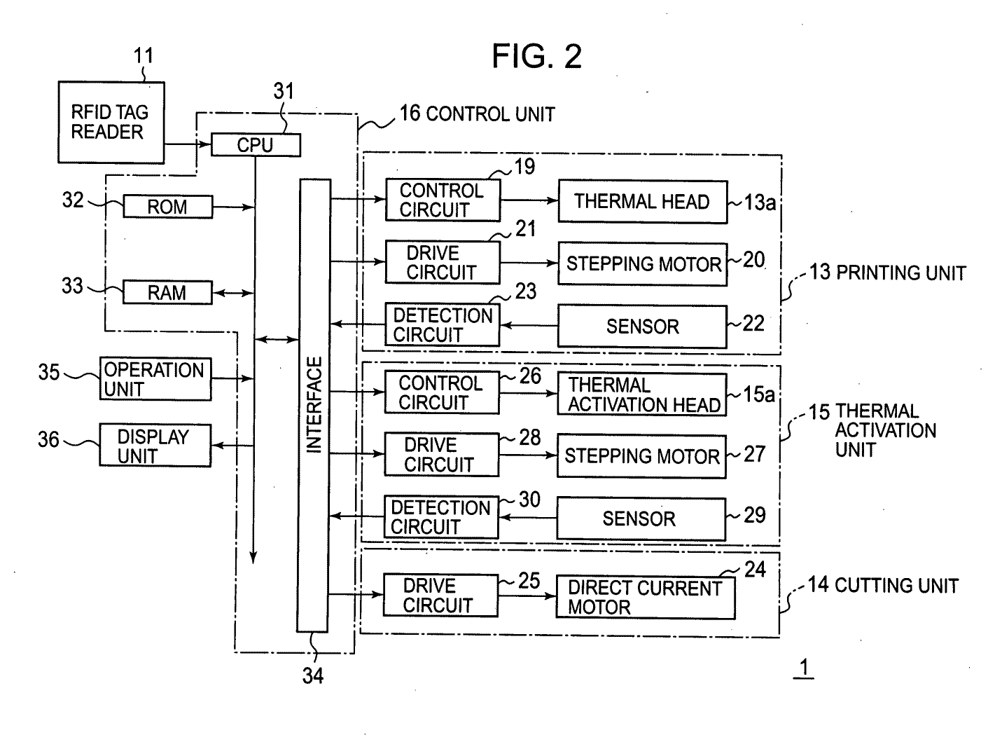

As shown in FIG. 1, the printing unit 13 includes a thermal head 13a for heating the heat-sensitive printing layer of the sheet material 4 to develop color, a head support member 13b for supporting the thermal head 13a, and a platen roller 13c brought into press contact with the thermal head 13a. In the printing unit 13, the sheet material 4, which is supplied from the sheet supply unit 12, is sandwiched between the thermal head 13a and the platen roller 13c, and is printed and transported. Further, as shown in FIG. 2, the printing unit 13 includes a control circuit 19 for controlling the thermal head 13a, a stepping motor 20 for rotationally driving the platen roller 13c, and a drive circuit 21 for driving the stepping motor 20. The control circuit 19 and the drive circuit 21 are each electrically connected to the control unit 16 via an interface 34. In addition, the printing unit 13 includes a sensor 22 and a detection circuit 23 for detecting the sheet material 4. The detection circuit 23 is electrically connected to the control unit 16 via the interface 34.

As shown in FIG. 1, the cutting unit 14 includes a pair of cutters 14a for cutting the sheet material 4 transported from the printing unit 13, and a cutter drive mechanism (not shown) for driving the pair of cutters 14a. The cutting unit 14 cuts the continuous-form sheet material 4, which is supplied from the sheet supply unit 12, into single-cut sheets with a desired length. Further, as shown in FIG. 2, the cutter drive mechanism includes a direct current (DC) motor 24 for driving the pair of cutters 14a, and a drive circuit 25 for driving the DC motor 24. The drive circuit 25 is electrically connected to the control unit 16 through the interface 34.

As shown in FIG. 1, the thermal activation unit 15 includes a thermal activation head 15a for heating the heat-sensitive adhesive layer of the sheet material 4 to develop an adhesive force thereof, a head support member 15b for supporting the thermal activation head 15a, and a platen roller 15c brought into press contact with the thermal activation head 15a. For the thermal activation head 15a, there is employed a thermal head similar to the thermal head 13a of the printing unit 13. In the thermal activation unit 15, the sheet material 4, which is transported from the cutting unit 14, is sandwiched between the thermal activation head 15a and the platen roller 15c to be heated so as to develop the adhesive force, and is transported. Further, the thermal activation unit 15 includes a pair of transport rollers 17a and 17b for transporting the sheet material 4, which is transported from the cutting unit 14, between the thermal activation head 15a and the platen roller 15c, and includes a drive mechanism (not shown) for rotationally driving the transport rollers 17a and 17b.

As shown in FIG. 2, the control unit 16 includes a central processing unit (CPU) 31, a read-only memory (ROM) 32, and a random-access memory (RAM) 33. The ROM 32 stores information regarding, for example, a length of the sheet material 4, and a shape and a size of the adhesive area for causing the heat-sensitive adhesive layer of the sheet material 4 to develop the adhesive force, with respect to a type of the RFID tag and information to be printed on the heat-sensitive printing layer. The sheet material production apparatus 1 includes an operation unit 35 for performing various operations, and a display unit 36 for displaying various information. The operation unit 35 and the display unit 36 are each electrically connected to the control unit 16.

Description is given of operations for producing a sheet material used as an RFID label in the sheet material production apparatus 1 having the structure described above.

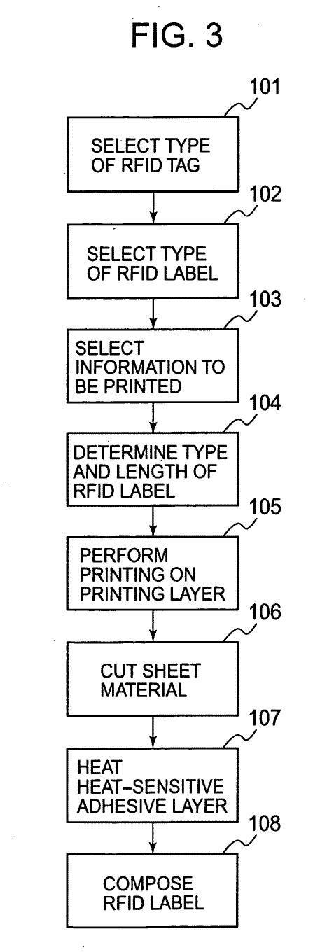

First, in the sheet material production apparatus 1, information recorded on the IC of the RFID tag is read by the RFID tag reader 11. The information read by the RFID'tag reader 11 is sent to the control unit 16. Subsequently, as shown in FIG. 3, the control unit 16 causes the display unit 36 to display the information based on the information read from the RFID tag by the RFID tag reader 11. Then, a user operates the operation unit 35 to select a type of the RFID tag such as a card type or a coin type (Step 101), to select a type of the RFID label such as a case type or a cover type to be described later (Step 102), and to select desired information to be printed on the heat-sensitive adhesive layer (Step 103). Alternatively, the control unit 16 may have a configuration for automatically selecting the type of the RFID tag, the type of the RFID label, and the information to be printed on the heat-sensitive printing layer, based on the information read from the RFID tag by the RFID tag reader 11.

Then, the control unit 16 determines an optimum type of the RFID label and an optimum length of the sheet material 4 in a transport direction, based on results of the above-mentioned selection (Step 104). Subsequently, the control unit 16 controls the printing unit 13 to print given information on the heat-sensitive printing layer of the sheet material 4 (Step 105), and controls the cutting unit 14 to cut the sheet material 4 with a predetermined length (Step 106). After that, the control unit 16 controls the thermal activation unit 15 to heat a predetermined area of the heat-sensitive adhesive layer of the sheet material 4 to develop the adhesive force thereof (Step 107).

Finally, the RFID tag is attached to a predetermined position on the heat-sensitive adhesive layer of the sheet material 4. The sheet material 4 is folded back so as to form a bag-like receiving portion for receiving the RFID tag, and the folded portions of the heat-sensitive adhesive layer are bonded together, thereby composing the RFID label (Step 108). The RFID label thus obtained has the RFID tag held in the bag-like receiving portion formed of the sheet material 4. The RFID label is to be attached to an article to be used in a state where the RFID tag is covered to be held.

Next, description is given of the RFID label composed using the sheet material 4 produced by the sheet material production apparatus 1 of the embodiment, with reference to the drawings.

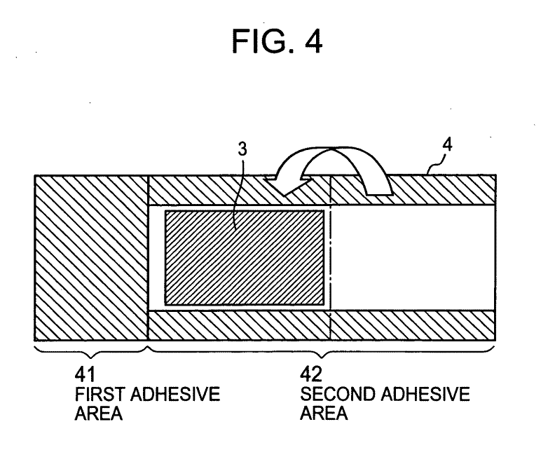

As shown in FIG. 4, the heat-sensitive adhesive layer of the sheet material 4, which is heated by the thermal activation unit 15, has a first adhesive area 41 in which the sheet material 4 is to be attached to an article, and a second adhesive area 42 in which the sheet material 4 is folded back in a bag shape for receiving the RFID tag 3, to be bonded.

The first adhesive area 41 is positioned on one edge side of the sheet material 4, which is supplied from the sheet supply unit 12, in the transport direction. The second adhesive area 42 is positioned on the other edge side of the sheet material 4 in the transport direction, and is provided in an area other than an area facing the RFID tag 3. The second adhesive area 42 is formed with a predetermined width along both sides of the sheet material 4 in the width direction orthogonal to the transport direction. The sheet material 4 has a bag-like receiving portion with one edge side being opened, which is formed by folding back the second adhesive area 42 to be bonded. As a result, it possible to easily take out the RFID tag 3 from the opening of the receiving portion.

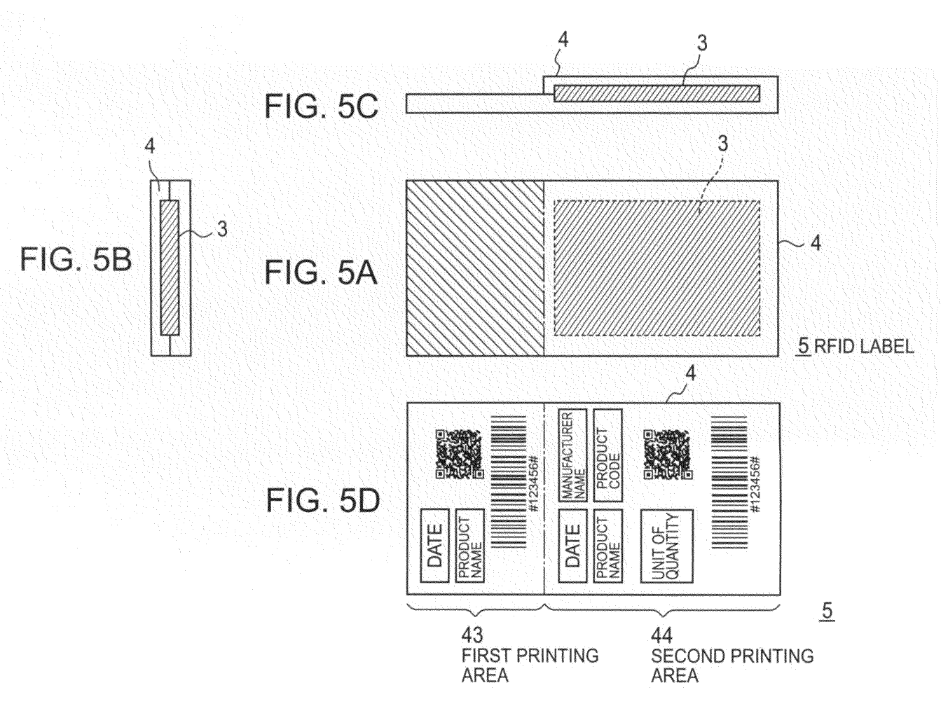

As shown in FIG. 5A, the RFID tag 3 of a card type is attached to the predetermined position on the heat-sensitive adhesive layer of the sheet material 4, and one edge side of the sheet material 4 is folded back to be bonded so as to cover the RFID tag 3 of the card type, thereby composing the RFID label 5. As shown in FIGS. 5B and 5C, the RFID label 5 is obtained by folding back the sheet material 4 to be bonded, whereby the RFID tag 3 is covered with the sheet material 4.

As shown in FIG. 5D, the heat-sensitive printing layer of the RFID label 5 has a first printing area 43 positioned on a back surface of the heat-sensitive adhesive layer at one edge side at which the first adhesive area 41 is positioned, and a second printing area 44 positioned on the back surface thereof at the other edge side at which the second adhesive area 42 is positioned. Accordingly, a portion corresponding to the first printing area 43 of the RFID label 5 is to be attached to an article.

On the first printing area 43, for example, date, a product name, and a barcode and a two-dimensional barcode which include those pieces of information are printed. On the second printing area 44, for example, information on date, a manufacturer name, a product name, quantity, and the like, and a barcode and a two-dimensional barcode which include those pieces of information are printed. Further, duplicate printing of a part of those pieces of information, such as a barcode and a two-dimensional barcode, on the first printing area 43 and the second printing area 44, enables sharing of the printed information between the article side and the RFID tag 3 side, even in a case where the portion corresponding to the first printing area 43 attached to the article and the portion corresponding to the second printing area 44 holding the RFID tag 3 are separated from each other when the RFID tag 3 is collected, for example, after the use of the RFID label 5.

In other words, in the case of the RFID label 5, when the RFID tag 3 is separated from the portion corresponding to the first printing area 43 together with the portion corresponding to the second printing area 44, the portion corresponding to the first printing area 43. is left on the article to which the RFID label 5 is attached. Accordingly, the information such as barcodes and characters printed on the first printing area 43 can be left on the article. The portion corresponding to the first printing area 43 of the RFID label 5 is left on the article in this manner, thereby making it possible to make an inquiry on various necessary information only from the article on hand, and to follow a delivery route or the like of the article.

The RFID label 5 is formed as an RFID label of a so-called case type for holding the RFID tag 3 by folding back the sheet material 4 to be bonded in a bag shape. Alternatively, the RFID label 5 may be formed as an RFID label of a so-called cover type to be attached to an article in a state where the RFID tag 3 is covered with the sheet material 4 which is not, folded back.

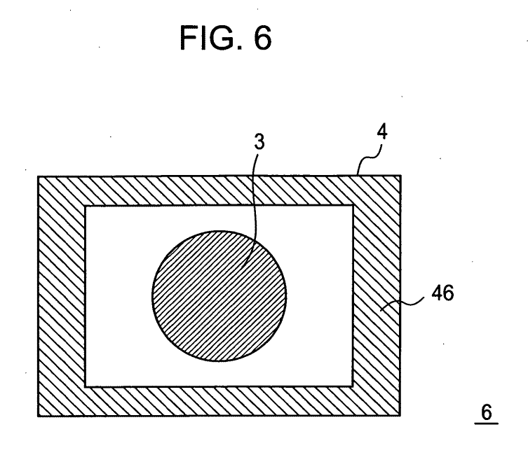

As shown in FIG. 6, the sheet material 4 forming an RFID label 6 of a cover type has a frame-like adhesive area 46 formed along an outer peripheral edge of the heat-sensitive adhesive layer. In the heat-sensitive adhesive layer of the sheet material 4, the adhesive force is not developed in an area facing the RFID tag 3 of a coin type.

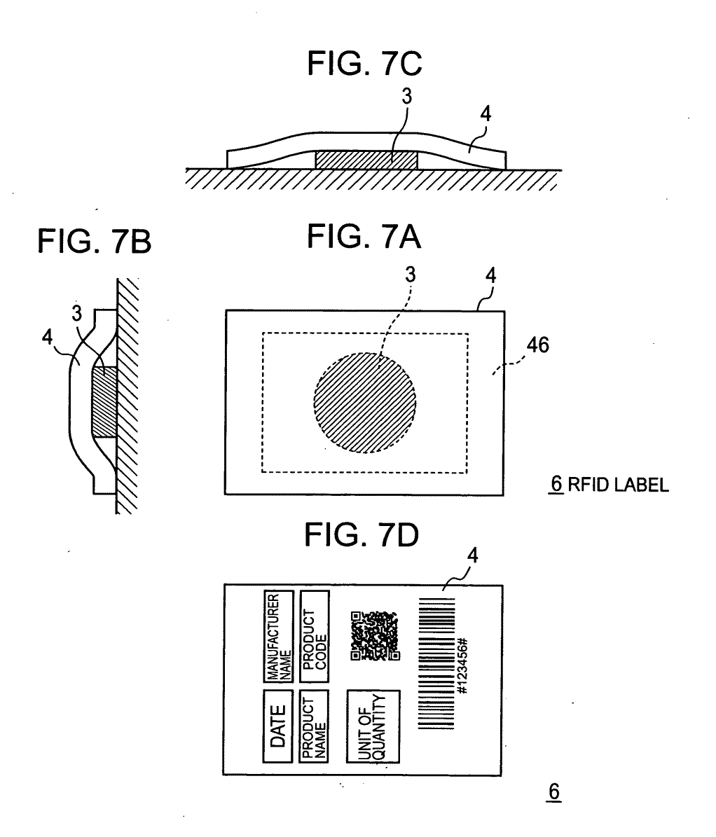

As shown in FIG. 7A, the RFID tag 3 of the coin type is positioned on an inner side of the frame-like adhesive area 46 of the heat-sensitive adhesive layer of the sheet material 4. Then, as shown in FIGS. 7B and 7C, the sheet material 4 is to be attached to an article through the adhesive area 46 with the RFID tag 3 of the coin type being covered. Accordingly, the RFID label 6 holds the RFID tag 3 sandwiched between the sheet material 4 and the article.

As shown in FIG. 7D, on the heat-sensitive printing layer of the sheet material 4 forming the RFID label 6 of the cover type, for example, information on date, a manufacturer name, an article code, and quantity, and information such as a barcode and a two-dimensional barcode including those pieces of information are printed in the same manner as in the case of the RFID label 5 of the label type.

The structure of the RFID label 6 of the cover type produced in the above-mentioned manner is simplified as compared with the RFID label 5 of the case type.

Finally, description is given of a modified example of the RFID label 5 of the case type with reference to the drawings.

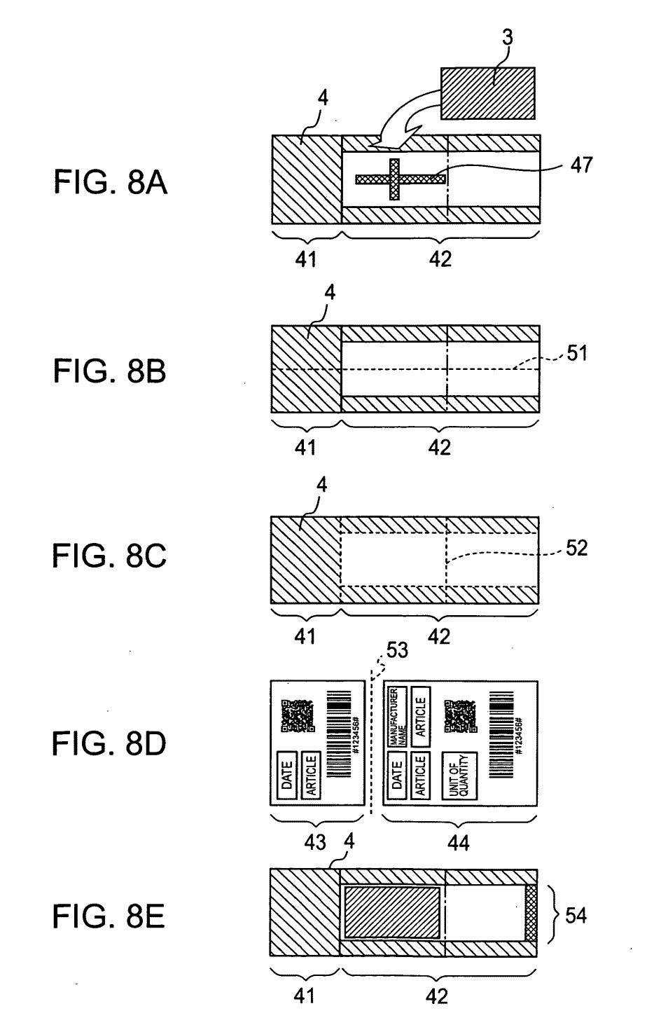

As Shown in FIG. 8A, the heat-sensitive adhesive layer of the sheet material 4 may have, for example, a cross-like third adhesive area 47 formed in an area facing the RFID tag 3 so as to position and temporarily fix the RFID tag 3. The RFID tag 3 can be temporarily fixed in this manner, thereby facilitating the positioning of the RFID tag 3 with respect to the sheet material 4 and the operation of folding back the sheet material 4 to be bonded.

Note that the thermal activation head 15a of the thermal activation unit 15 selectively heats the heat-sensitive adhesive layer of the sheet material 4 in units of dots so as to change the density of the area in which the adhesive force is developed, thereby enabling control of the magnitude of the adhesive force developed in the heat-sensitive adhesive layer. In addition, the thermal activation unit 15 adjusts the size of the adhesive area of the heat-sensitive adhesive layer, in which the adhesive force is developed, and adjusts the shape of the adhesive area, thereby enabling control the magnitude of the adhesive force. Accordingly, in order to easily remove the RFID tag 3 from the heat-sensitive adhesive layer when the RFID label 5 is decomposed, the thermal activation unit 15 may adjust the magnitude of the adhesive force to be varied for each adhesive area of the heat-sensitive adhesive layer such that the adhesive force of the third adhesive area 47 for temporarily fixing the RFID tag 3 becomes smaller than that of the first adhesive area 41 to be attached to an article and that of the second adhesive area 42 in which the sheet material 4 is folded back to be bonded.

Further, as shown in FIG. 8B, the sheet material 4 supplied from the sheet supply roll 12a of the sheet supply unit 12 may have a perforation (cutoff line) 51 formed along the transport direction of the sheet material 4 such that, for example, the perforation 51 passes through the center in the width direction. With the RFID label 5, the sheet material 4 can be easily ripped along the perforation 51, thereby making it possible to easily take out the RFID tag 3. The perforation 51 is formed along the transport direction of the sheet material 4 in the above-mentioned manner, so the perforation 51 can be provided at the predetermined position of the sheet material 4 without any effect of the change in length of the RFID label 5 to be produced, that is, length of the sheet material 4 to be cut into single-cut sheets.

Further, if necessary, as shown in FIG. 8C, on the heat-sensitive printing layer of the sheet material 4, a pleat line 52 at which the sheet material 4 is folded back in the second adhesive area 42 to be bonded may be printed over the sheet material 4 in the width direction. When the RFID label 5 is composed, the sheet material 4 is folded back along the pleat line 52, thereby facilitating the operation of bonding the sheet material 4.

Further, as shown in FIG. 8D, the sheet material 4 may have a perforation 53 formed along the width direction of the sheet material 4. On the heat-sensitive printing layer of the sheet material 4, the first printing area 43 and the second printing area 44 are formed such that a boundary is formed therebetween by the perforation 53. As a result, in the case of using the RFID label 5, the portion corresponding to the first printing area 43 attached to an article and the portion corresponding to the second printing area 44 holding the RFID tag 3 can be easily separated from each other.

Further, if necessary, as shown in FIG. 8E, the heat-sensitive printing layer of the sheet material 4 may have an adhesive area 54 formed at an edge portion on the second adhesive area 42 side in the width direction of the sheet material 4. As a result, when the sheet material 4 is folded back to be bonded, the adhesive area 54 is bonded together, thereby making it possible to seal the opening of the bag-like receiving portion in which the RFID tag 3 is received, and to reliably prevent the RFID tag 3 from being dropped from the sheet material 4.

As described above, in the sheet material production apparatus 1, the control unit 16 controls each of the printing unit 13, the cutting unit 14, and the thermal activation unit 15 based on the information read from the RFID tag 3 by the RFID tag reader 11. As a result, the production of the RFID labels 5 and 6 of a desired type can be facilitated based on the information read from the RFID tag 3, the information of the RFID tag 3 can be matched with the information printed on the sheet material 4 with reliability, and the RFID tag 3 can be simply attached to an article with the sheet material 4.

Further, as regards the RFID labels 5 and 6 formed of the sheet material 4 produced by the sheet material production apparatus 1, it is possible to reduce the adhesive force of the heat-sensitive adhesive layer by reheating the heat-sensitive adhesive layer. As a result, the sheet material 4 which is folded back to be bonded can be easily separated and the RFID tag 3 can be easily taken out therefrom. Accordingly, with the sheet material production apparatus 1, the RFID labels 5 and 6 which can be easily decomposed can be produced, and the RFID tag 3 can be reused with ease.

In addition, in the sheet material production apparatus 1, printing is performed on the heat-sensitive printing layer of a single sheet material 4, so the printing can be satisfactorily performed on the heat-sensitive printing layer with flatness, and printing quality of the RFID labels 5 and 6 can be improved. Further, the heat-sensitive adhesive layer of the sheet material 4 is heated separately, thereby preventing heat and a pressing force from acting on the RFID tag 3 and securing an operation reliability of the RFID tag 3.

Note that the sheet material production apparatus 1 according to the embodiment of the present invention may have a structure further including an RFID tag writer for deleting information recorded on the IC of the RFID tag 3 and for recording additional information on the IC.

Further, the sheet material production apparatus 1 according to the embodiment may have a structure further including a tag attaching device (not shown) for attaching the RFID tag 3 at a predetermined position on the heat-sensitive adhesive layer of the sheet material 4.

What is claimed is:

1. A method of producing a sheet material for attachment to an article and for covering a tag which contains an antenna and an integrated circuit that are electrically connected to each other and are coated with a coating material, and to/from which information can be written/read in a non-contact state, the method comprising the steps of:
reading information of the tag from the tag before the tag is covered by sheet material;
supplying a sheet material having a printing layer on one surface of a sheet-type base material and a heat-sensitive adhesive layer on the other surface of the sheet-type base material;
developing an adhesive force in a predetermined area of the heat-sensitive adhesive layer, other than an area facing the tag when the tag is covered by sheet material, so as to form an adhesive area to be attached to an article, based on the information read from the tag before the tag is covered by sheet material; and
printing predetermined information on the printing layer based on the information read from the tag before the tag is covered by sheet material.

2. A method of producing a sheet material according to claim 1; further comprising the step of cutting the sheet material in a continuous form into single-cut sheets with a predetermined length, based on the information read from the tag before the tag is covered with sheet material.

3. A method of producing a printed sheet material for attaching a radio frequency identification (RFID) tag to an article, the method comprising the steps of:
providing a RFID tag having an integrated circuit into which is written information;
reading the information from the RFID tag;
providing a sheet material having a printing layer on one side thereof and a heat-sensitive adhesive layer on the other side thereof, the sheet material being spaced from and not attached to the RFID tag;
printing predetermined information on the printing layer of the sheet material based on the information read from the RFID tag; and
thermally activating the heat-sensitive adhesive layer of the printed sheet material in a predetermined area thereof, based on the information read from the RFID tag, to form an adhesive area for attachment of the printed sheet material to an article with the RFID tag sandwiched therebetween.

4. A method according to claim 3; wherein the thermally activating step comprises thermally activating the heat-sensitive adhesive layer to form a first adhesive area to be attached to the article and a second adhesive area where the sheet material can be folded back and adhered to itself to form a compartment for holding the RFID tag.

5. A method according to claim 4; wherein the printing step comprises printing duplicate information on a first printing area located on a back surface of the first adhesive area and on a second printing area located on a back surface of the second adhesive area.

6. A method according to claim 3; wherein the printing layer of the sheet material comprises a heat-sensitive printing layer.

7. A method according to claim 3; further comprising the step of cutting the printed sheet material into sheets of predetermined length based on the information read from the RFID tag.
